(19) United States
(12) Patent Application Publication
(10) Pub. No.: US 2016/0320959 A1
(43) Pub. Date: Nov. 3, 2016

(54) Terminal Operation Apparatus and Terminal Operation Method

(71) Applicant: YULONG COMPUTER TELECOMMUNICATION SCIENTIFIC (SHENZHEN) CO., LTD., Shenzhen, Guangdong (CN)

(72) Inventor: Jingen Sheng, Shenzhen, Guangdong (CN)

(21) Appl. No.: 15/108,466

(22) PCT Filed: Jan. 15, 2014
(86) PCT No.: PCT/CN2014/070638

§ 371 Date: Jun. 27, 2016

(51) Int. Cl. G06F 3/0488; G06F 17/30; G06F 3/0482

(52) U.S. Cl. CPC G06F 3/04883; G06F 3/0482; G06F 17/30117; G06F 17/30091; G06F 2203/04808

(57) ABSTRACT

The present invention provides a terminal operation device and a terminal operation method, wherein the terminal operation device includes: a display unit used for displaying a list with a plurality of information items; a judging unit used for judging whether displaying an information item between two specified information items according to a received operation instruction of the two specified information items in the list; and a processing unit used for processing the information item between the two specified information items according to a judgment result of the judging unit. By means of the technical solutions provided by the present invention, a user can conveniently manage the list on a terminal display interface by simple operations, thereby improving the operation efficiency and being conducive to improving the operation experience of the user.

### FIELD OF THE INVENTION

The present invention relates to the technical field of terminal manipulation, and in particular, to a terminal operation device and a terminal operation method.

### BACKGROUND OF THE INVENTION

In related technology, operation modes of a list on a terminal display interface mainly include: sliding on the list to execute related operations, long pressing information items in the list to pop up related operation hints, or entering list details to execute the operations, and for some information with privacy, corresponding passwords need to be input to enter corresponding modes to execute the operations.

However, with regard to the method of directly sliding on the list to execute the related operations, due to the limitation of the list region, only a few common operations can be supported; and with regard to the method of long pressing the information items in the list to pop up the related operation hints and the method of entering the list details to execute the operations, the operations are relatively tedious, such that a user cannot operate the list quickly.

Therefore, how to conveniently enable the user to operate a plurality of information items on the terminal display interface becomes a technical problem to be solved urgently.

### SUMMARY OF THE INVENTION

The present invention proposes a new terminal operation solution based on at least one of the above technical problems, such that a user can conveniently manage a list on a terminal display interface by simple operations, thereby improving the operation efficiency and being conducive to improving the operation experience of the user.

In view of this, the present invention proposes a terminal operation device, including: a display unit used for displaying a list with a plurality of information items; a judging unit used for judging whether displaying an information item between two specified information items according to a received operation instruction of the two specified information items in the list; and a processing unit used for processing the information item between the two specified information items according to a judgment result of the judging unit.

In the technical solution, when the operation instruction of the two specified information items in the list is received, whether displaying the information item between the two specified information items according to the received operation instruction is processed, such that the user can conveniently manage the list on the terminal display interface by simple operations, thereby improving the operation efficiency and being conducive to improving the operation experience of the user.

In the above technical solution, preferably, the judging unit is specifically used for: when receiving a first operation instruction of two spaced information items in the list, judging not to display the information item between the two spaced information items.

In the technical solution, for example, when the user needs to delete a specified information item in the list, in the operation mode in related technology the information item to be deleted needs to be long pressed to pop up a prompt message and delete the information item according to the prompt message, or when the user needs to add a specified information item in the list to a private list, the user needs to set in a private mode, the operation process is tedious, and a lot of time of the user is wasted, but by means of the manner that when receiving the first operation instruction of the two spaced information items in the list, the information item between the two spaced information items is not displayed, the user can operate two information items adjacent to the specified information item in the list when needing not to display the specified information item (for example, delete the specified information item or add the specified information item to the private list and the like), thereby greatly facilitating the user operation and improving the user experience.

In the above technical solution, preferably, when the judging unit judges not to display the information item between the two spaced information items, the processing operation of the processing unit on the information item between the two spaced information items includes: deleting the information item between the two spaced information items, or storing the information item between the two spaced information items in a specified storage space or hiding the information item between the two spaced information items.

In the technical solution, specifically, the storing the information item between the two spaced information items in a specified storage space can be storing the information item between the two spaced information items in a private space or adding the information item between the two spaced information items to a backlist, and the like.

In the above technical solution, preferably, the terminal operation device further includes: an association unit used for associating the first operation instruction with a specified processing operation according to a received association instruction, for enabling the processing unit to process the information item between the two spaced information items according to the processing operation associated with the first operation instruction.

In the technical solution, since the first operation instruction is associated with the specified processing operation, when receiving the first operation instruction of the user, a terminal can identify the operation intension of the user to execute a corresponding processing operation. Specifically, a manufacturer of the terminal can preset the processing operation corresponding to the first operation instruction (for example, deleting the information item between the two spaced information items is used as the preset processing operation corresponding to the first operation instruction), when in use, the user can modify the corresponding processing operation (for example, modify a deletion operation to an operation of storing the information item between the two spaced information items in the private space).

In the above technical solution, preferably, the processing unit is further used for: when receiving the first operation instruction, selecting the processing operation on the information item between the two spaced information items according to the attribute of the information item between the two spaced information items, so as to process the information item between the two spaced information items.

In the technical solution, for example, an information item B is an information item between an information item A and an information item C, if it is determined that the information item B belongs to private information according to the preset of the user, when the first operation instruction is executed on the information item A and the information item C, the information item B can be directly put in the private space; if it is determined that the information item B belongs to junk information according to the preset of the user, when the first operation instruction is executed on the information item A and the information item C, the information item B can be directly deleted; and if it is determined that the information item B belongs to information needing to be hidden, when the first operation instruction is executed on the information item A and the information item C, the information item B can be directly hidden.

Of course, the terminal can also count the operation habits of the user, for example, when the times of the user for adding the information of a linkman E to the private space exceed preset times, the terminal determines the information of the linkman E as private information, when the information of the linkman E is located between spaced information D and information F, and when executing the first operation instruction on the information D and the information F, the terminal directly adds the information E to the private space.

In the above technical solution, preferably, the first operation instruction includes a kneading gesture or a separation gesture.

In the technical solution, the kneading gesture is executed on the two spaced information items to not display the information item between the two spaced information items, such that the operation process is vivid, and the pleasure of the user operation is improved. The separation gesture is executed on the two spaced information items to not display the information item between the two spaced information items, for example, when executing the deletion operation, when the separation gesture is executed on the two spaced information items, an animation of putting the information item between the two spaced information items in a dustbin can be played between the two spaced information items, such that the operation process is vivid, similarly.

In the above technical solution, preferably, the judging unit is further used for: when receiving a second operation instruction of two adjacent information items in the list, judging to display a non-displayed information item between the two adjacent information items.

In the technical solution, when the user needs to display the hidden information item in the list, for example, display the information item added to the private space, the operation mode in the related technology is to set in the private space in general, the operation process is tedious, and a lot of time of the user is wasted, but by means of the manner that when receiving the second operation instruction of two adjacent information items in the list, the non-displayed information item between the two adjacent information items is displayed, the user only needs to operate the two adjacent information items in the list, thereby greatly facilitating the operation process of the user and improving the user experience.

In the above technical solution, preferably, the non-displayed information item includes an information item stored in the specified storage space or a hidden information item.

In the technical solution, specifically, the information item stored in the specified storage space can be an information item added to the private space or an information item added to the blacklist.

In the above technical solution, preferably, the second operation instruction includes a separation gesture.

In the technical solution, the separation gesture is executed on the two adjacent information items to display the information item between the two connected information items, such that the operation process is vivid, and the pleasure of the user operation is improved.

According to another aspect of the present invention, a terminal is further proposed, including the terminal operation device in any above technical solution.

According to another aspect of the present invention, a terminal operation method is further proposed, including: displaying a list with a plurality of information items judging whether displaying an information item between two specified information items according to a received operation instruction of the two specified information items in the list, so as to obtain a judgment result; and processing the information item between the two specified information items according to the judgment result.

In the technical solution, when the operation instruction of the two specified information items in the list is received, whether displaying the information item between the two specified information items according to the received operation instruction is processed, such that the user can conveniently manage the list on the e terminal display interface by simple operations, thereby improving the operation efficiency and being conducive to improving the operation experience of the user.

In the above technical solution, preferably, when receiving a first operation instruction of two spaced information items in the list, judging not to display the information item between the two spaced information items.

In the technical solution, for example, when the user needs to delete a specified. information item in the list, in the operation mode in related technology the information item to be deleted needs to be long pressed to pop up a prompt message and delete the information item according to the prompt message, or when the user needs to add a specified information item in the list to a private list, the user needs to set in a private mode, the operation process is tedious, and a lot of time of the user is wasted, but by means of the manner that when receiving the first operation instruction of the two spaced information items in the list, the information item between the two spaced information items is not displayed, the user can operate two information items adjacent to the specified information item in the list when needing not to display the specified information item (for example, delete the specified information item or add the specified information item to the private list and the like), thereby greatly facilitating the user operation and improving the user experience.

In the above technical solution, preferably, the processing operation of not displaying the information item between the two spaced information items includes: deleting the information item between the two spaced information items, or storing the information item between the two spaced information items in a specified storage space or hiding the information item between the two spaced information items.

In the technical solution, specifically, the storing the information item between the two spaced information items in a specified storage space can be storing the information item between the two spaced information items in a private space or adding the information item between the two spaced information items to a backlist, and the like. In the above technical solution, preferably, before receiving the first operation instruction of the two spaced information items in the list, the terminal operation method further includes: associating the first operation instruction with a specified processing operation according to a received association instruction, so as to process the information item between the two spaced information items according to the processing operation associated with the first operation instruction, when judging not to display the information item between the two spaced information items.

In the technical solution, since the first operation instruction is associated with the specified processing operation, when receiving the first operation instruction of the user, a terminal can identify the operation intension of the user to execute a corresponding processing operation. Specifically, a manufacturer of the terminal can preset the processing operation corresponding to the first operation instruction (for example, deleting the information item between the two spaced information items is used as the preset processing operation corresponding to the first operation instruction), when in use, the user can modify the corresponding processing operation (for example, modify a deletion operation to an operation of storing the information item between the two spaced information items in the private space).

In the above technical solution, preferably, the first operation instruction includes a kneading gesture or a separation gesture.

In the technical solution, the kneading gesture is executed on the two spaced information items to not display the information item between the two spaced information items, such that the operation process is vivid, and the pleasure of the user operation is improved. The separation gesture is executed on the two spaced information items to not display the information item between the two spaced information items, for example, when executing the deletion operation, when the separation gesture is executed on the two spaced information items, an animation of putting the information item between the two spaced information items in a dustbin can be played between the two spaced information items, such that the operation process is vivid similarly.

In the above technical solution, preferably, when receiving a second operation instruction of two adjacent information items in the list, judging to display a non-displayed information item between the two adjacent information items.

In the technical solution, when the user needs to display the hidden information item in the list, for example, display the information item added to the private space, the operation mode in the related technology is to set in the private space in general, the operation process is tedious, and a lot of time of the user is wasted, but by means of the manner that when receiving the second operation instruction of two adjacent information items in the list, the non-displayed information item between the two adjacent information items is displayed, the user only needs to operate the two adjacent information items in the list, thereby greatly facilitating the operation process of the user and improving the user experience.

In the above technical solution, preferably, the non-displayed information item includes an information item stored in the specified storage space or a hidden information item.

In the technical solution, specifically, the information item stored in the specified storage space can be an information item added to the private space or an information item added to the blacklist.

In the above technical solution, preferably, the second operation instruction includes a separation gesture.

In the technical solution, the separation gesture is executed on the two adjacent information items to display the information item between the two connected information items, such that the operation process is vivid, and the pleasure of the user operation is improved.

By means of the above technical solutions, the user can conveniently manage the list on the terminal display interface by simple operations, thereby improving the operation efficiency and being conducive to improving the operation experience of the user.

### BRIEF DESCRIPTION OF THE DRAWINGS

FIG. 1 shows a schematic block diagram of a terminal operation device according to an embodiment of the present invention;

FIG. 2 shows a schematic diagram of a flow of a terminal operation method according to an embodiment of the present invention;

FIG. 3 shows a schematic diagram of a flow of a terminal operation method according to another embodiment of the present invention;

FIG. 4A to FIG. 4C show a schematic diagram of a terminal operation interface according to an embodiment of the present invention.

### DETAILED DESCRIPTION OF THE EMBODIMENTS

In order to understand the above purposes, features and advantages of the present invention more clearly, a further detailed description of the present invention will be given below in combination with the accompanying drawings and specific embodiments. It should be noted that, the embodiments and the features in the embodiments of the present application can be mutually combined as long as no conflict is generated.

A large number of specific details are illustrated in the description below to fully understand the present invention, however, the present invention can also be implemented in other manners different from what is described herein, therefore, the protection scope of the present invention is not limited by the specific embodiments disclosed below.

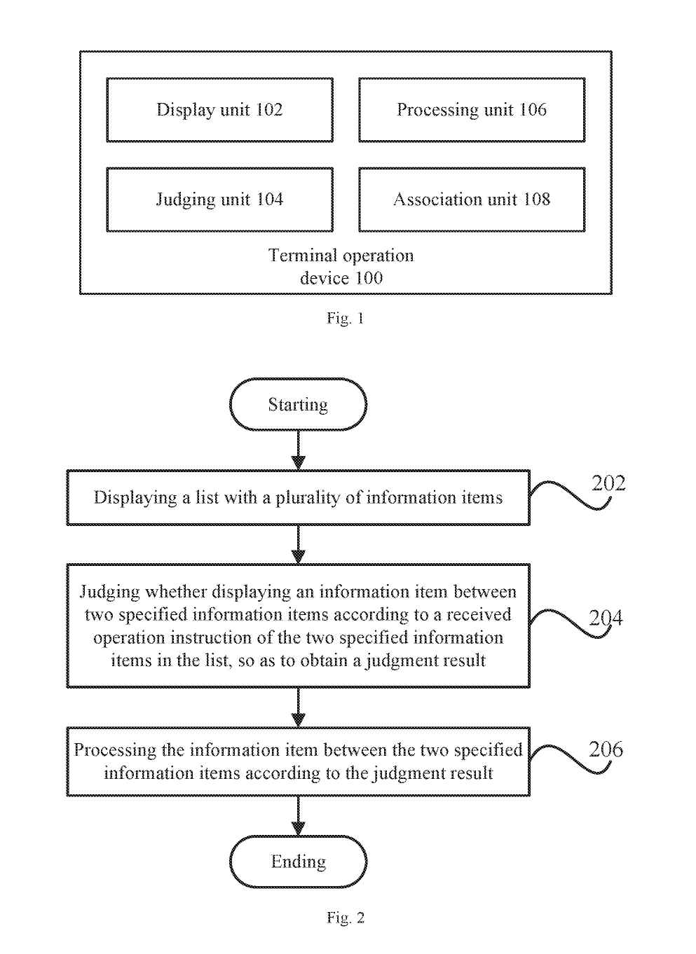

FIG. 1 shows a schematic block diagram of a terminal operation device according to an embodiment of the present invention.

As shown in FIG. 1, the terminal operation device 100 according to the embodiment of the present invention includes: a display unit 102 used for displaying a list with a plurality of information items; a judging unit 104 used for judging whether displaying an information item between two specified information items according to a. received operation instruction of the two specified information items in the list; and a processing unit 106 used for processing the information item between the two specified information items according to a judgment result of the judging unit 104.

In the technical solution, when the operation instruction of the two specified information items in the list is received, whether displaying the information item between the two specified information items according to the received operation instruction is processed, such that the user can conveniently manage the list on the terminal display interface by simple operations, thereby improving the operation efficiency and being conducive to improving the operation experience of the user.

In the above technical solution, preferably, the judging unit 104 is specifically used for: when receiving a first operation instruction of two spaced information items in the list, judging not to display the information item between the two spaced information items.

In the technical solution, for example, when the user needs to delete a specified information item in the list, in the operation mode in related technology the information item to be deleted needs to be long pressed to pop up a prompt message and delete the information item according to the prompt message, or when the user needs to add a specified information item in the list to a private list, the user needs to set in a private mode, the operation process is tedious, and a lot of time of the user is wasted, but by means of the manner that when receiving the first operation instruction of the two spaced information items in the list, the information item between the two spaced information items is not displayed, the user can operate two information items adjacent to the specified information item in the list when needing not to display the specified information item (for example, delete the specified information item or add the specified information item to the private list and the like), thereby greatly facilitating the user operation and improving the user experience.

In the above technical solution, preferably, when the judging unit 104 judges not to display the information item between the two spaced information items, the processing operation of the processing unit 106 on the information item between the two spaced information items includes: deleting the information item between the two spaced information items, or storing the information item between the two spaced information items in a specified storage space or hiding the information item between the two spaced information items.

In the technical solution, specifically, the storing the information item between the e two spaced information items in a specified storage space can be storing the information item between the two spaced information items in a private space or adding the information item between the two spaced information items to a backlist, and the like.

In the above technical solution, preferably, the terminal operation device further includes: an association unit 108 used for associating the first operation instruction with a specified processing operation according to a received association instruction, for enabling the processing unit 106 to process the information item between the two spaced information items according to the processing operation associated with the first operation instruction.

In the technical solution, since the first operation instruction is associated with the specified processing operation, when receiving the first operation instruction of the user, a terminal can identify the operation intension of the user to execute a corresponding processing operation. Specifically, a manufacturer of the terminal can preset the processing operation corresponding to the first operation instruction (for example, deleting the information item between the two spaced information items is used as the preset processing operation corresponding to the first operation instruction), when in use, the user can modify the corresponding processing operation (for example, modify a deletion operation to an operation of storing the information item between the two spaced information items in the private space).

In the above technical solution, preferably, the processing unit 106 is further used for: when receiving the first operation instruction, selecting the processing operation on the information item between the two spaced information items according to the attribute of the information item between the two spaced information items, so as to process the information item between the two spaced information items.

In the technical solution, for example, an information item B is an information item between an information item A and an information item C, if it is determined that the information item B belongs to private information according to the preset of the user, when the first operation instruction is executed on the information item A and the information item C, the information item B can be directly put in the private space; if it is determined that the information item B belongs to junk information according to the preset of the user, when the first operation instruction is executed on the information item A and the information item C, the information item B can be directly deleted; and if it is determined that the information item B belongs to information needing to be hidden, when the first operation instruction is executed on the information item A and the information item C, the information item B can be directly hidden.

Of course, the terminal can also count the operation habits of the user, for example, when the times of the user for adding the information of a linkman E to the private space exceed preset times, the terminal determines the information of the linkman E as private information, when the information of the linkman E is located between spaced information D and information F, and when executing the first operation instruction on the information D and the information F, the terminal directly adds the information E to the private space.

In the above technical solution, preferably, the first operation instruction includes a kneading gesture or a separation gesture.

In the technical solution, the kneading gesture is executed on the two spaced information items to not display the information item between the two spaced information items, such that the operation process is vivid, and the pleasure of the user operation is improved, The separation gesture is executed on the two spaced information items to not display the information item between the two spaced information items, for example, when executing the deletion operation, when the separation gesture is executed on the two spaced information items, an animation of putting the information item between the two spaced information items in a dustbin can be played between the two spaced information items, such that the operation process is vivid similarly.

In the above technical solution, preferably, the judging unit 104 is further used for: when receiving a second operation instruction of two adjacent information items in the list, judging to display a non-displayed information item between the two adjacent information items.

In the technical solution, when the user needs to display the hidden information item in the list, for example, display the information item added to the private space, the operation mode in the related technology is to set in the private space in general, the operation process is tedious, and a lot of time of the user is wasted, but by means of the manner that when receiving the second operation instruction of two adjacent information items in the list, the non-displayed information item between the two adjacent information items is displayed, the user only needs to operate the two adjacent information items in the list, thereby greatly facilitating the operation process of the user and improving the user experience.

In the above technical solution, preferably, the non-displayed information item includes an information item stored in the specified storage space or a hidden information item.

In the technical solution, specifically, the information item stored in the specified storage space can be an information item added to the private space or an information item added to the blacklist.

In the above technical solution, preferably, the second operation instruction includes a separation gesture.

In the technical solution, the separation gesture is executed on the two adjacent information items to display the information item between the two connected information items, such that the operation process is vivid, and the pleasure of the user operation is improved.

FIG. 2 shows a schematic diagram of a flow of a terminal operation method according to an embodiment of the present invention.

As shown in FIG. 2, the terminal operation method according to the embodiment of the present invention includes: step 202, displaying a list with a plurality of information items; step 204, judging whether displaying an information item between two specified information items according to a received operation instruction of the two specified information items in the list, so as to obtain a judgment result; and step 206, processing the information item between the two specified information items according to the judgment result.

In the technical solution, when the operation instruction of the two specified information items in the list is received, whether displaying the information item between the two specified information items according to the received operation instruction is processed, such that the user can conveniently manage the list on the terminal display interface by simple operations, thereby improving the operation efficiency and being conducive to improving the operation experience of the user.

In the above technical solution, preferably, when receiving a first operation instruction of two spaced information items in the list, judging not to display the information item between the two spaced information items.

In the technical solution, for example, when the user needs to delete a specified information item in the list, in the operation mode in related technology the information item to be deleted needs to be long pressed to pop up a prompt message and delete the information item according to the prompt message, or when the user needs to add a specified information item in the list to a private list, the user needs to set in a private mode, the operation process is tedious, and a lot of time of the user is wasted, but by means of the manner that when receiving the first operation instruction of the two spaced information items in the list, the information item between the two spaced information items is not displayed, the user can operate two information items adjacent to the specified information item in the list when needing not to display the specified information item (for example, delete the specified information item or add the specified information item to the private list and the like), thereby greatly facilitating the user operation and improving the user experience.

In the above technical solution, preferably, the processing operation of not displaying the information item between the two spaced information items includes: deleting the information item between the two spaced information items, or storing the information item between the two spaced information items in a specified storage space or hiding the information item between the two spaced information items.

In the technical solution, specifically, the storing the information item between the two spaced information items in a specified storage space can be storing the information item between the two spaced information items in a private space or adding the information item between the two spaced information items to a backlist, and the like.

In the above technical solution, preferably, before receiving the first operation instruction of the two spaced information items in the list, the terminal operation method further includes: associating the first operation instruction with a specified processing operation according to a received association instruction, so as to process the information item between the two spaced information items according to the processing operation associated with the first operation instruction, when judging not to display the information item between the two spaced information items.

In the technical solution, since the first operation instruction is associated with the specified processing operation, when receiving the first operation instruction of the user, a terminal can identify the operation intension of the user to execute a corresponding processing operation. Specifically, a manufacturer of the terminal can preset the processing operation corresponding to the first operation instruction (for example, deleting the information item between the two spaced information items is used as the preset processing operation corresponding to the first operation instruction), when in use, the user can modify the corresponding processing operation (for example, modify a deletion operation to an operation of storing the information item between the two spaced information items in the private space).

In the above technical solution, preferably, the first operation instruction includes a kneading gesture or a separation gesture.

In the technical solution, the kneading gesture is executed on the two spaced information items to not display the information item between the two spaced information items, such that the operation process is vivid, and the pleasure of the user operation is improved. The separation gesture is executed on the two spaced information items to not display the information item between the two spaced information items, for example, when executing the deletion operation, when the separation gesture is executed on the two spaced information items, an animation of putting the information item between the two spaced information items in a dustbin can be played between the two spaced information items, such that the operation process is vivid similarly.

In the above technical solution, preferably, when receiving a second operation instruction of two adjacent information items in the list, judging to display a non-displayed information item between the two adjacent information items.

In the technical solution, when the user needs to display the hidden information item in the list, for example, display the information item added to the private space, the operation mode in the related technology is to set in the private space in general, the operation process is tedious, and a lot of time of the user is wasted, but by means of the manner that when receiving the second operation instruction of two adjacent information items in the list, the non-displayed information item between the two adjacent information items is displayed, the user only needs to operate the two adjacent information items in the list, thereby greatly facilitating the operation process of the user and improving the user experience.

In the above technical solution, preferably, the non-displayed information item includes an information item stored in the specified storage space or a hidden information item.

In the technical solution, specifically, the information item stored in the specified storage space can be an information item added to the private space or an information item added to the blacklist.

In the above technical solution, preferably, the second operation instruction includes a separation gesture.

In the technical solution, the separation gesture is executed on the two adjacent information items to display the information item between the two connected information items, such that the operation process is vivid, and the pleasure of the user operation is improved.

FIG. 3 shows a schematic diagram of a flow of a terminal operation method according to another embodiment of the present invention.

As shown in FIG. 3, the terminal operation method according to another embodiment of the present invention includes:

step 302, detecting a user gesture;

step 304, judging whether double fingers in the user gesture are kneaded or separated from two specified information items, if so, executing step 306, and if not, executing step 308;

step 306, when judging that the double fingers in the user gesture are kneaded or separated from the two specified information items, executing a set operation. For example, when judging that the double fingers in the user gesture are kneaded or separated from the two spaced information items, the information item between two spaced information items is not displayed; when judging that the double fingers in the user gesture are separated from the two adjacent information items, the non-displayed information item between the two adjacent information items is displayed, and when judging that the double fingers in the user gesture are kneaded from the two adjacent information items, the two adjacent information items can be merged; and

step 308, when judging that the double fingers in the user gesture are not kneaded or separated from two lists, executing other operations.

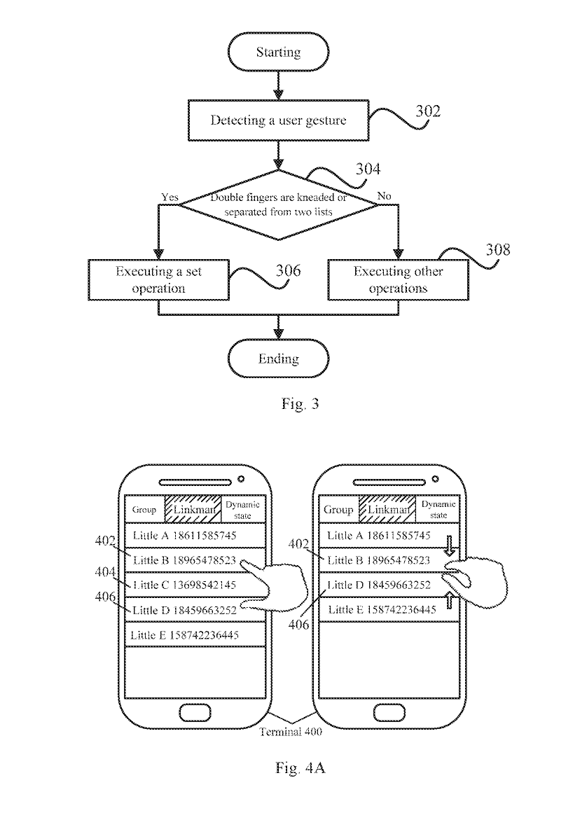

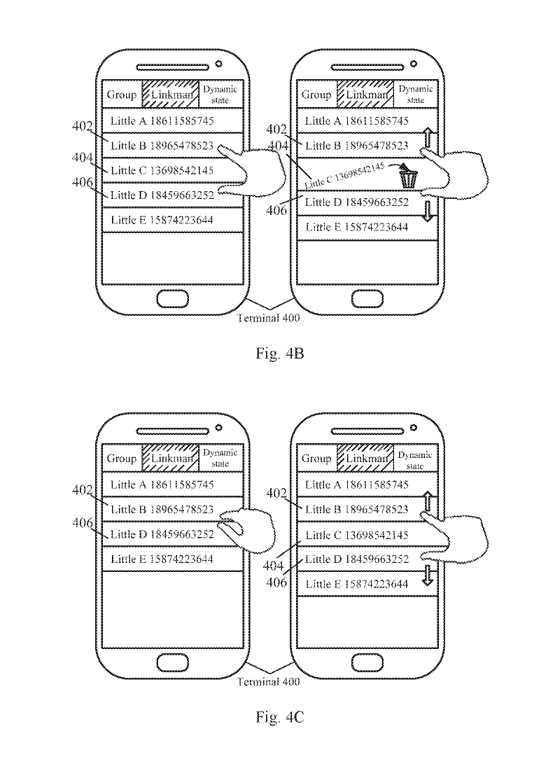

The terminal operation solution according to the embodiment of the present invention will be illustrated below in detail in combination with FIG. 4A to FIG. 4C.

FIG. 4A to FIG. 4C show a schematic diagram of a terminal operation interface according to an embodiment of the present invention.

As shown in FIG. 4A, a contact list is displayed on a display interface of a terminal 400, when a user needs to add an information item 404 in the contact list to a private space (or delete the information item and the like), the user can execute a kneading gesture on an information item 402 and an information item 406 adjacent to the information item 404, so as not to display the information item 402 in the contact list, and the operation process is vivid.

As shown in FIG. 4B, the contact list is displayed on the display interface of the terminal 400, when the user needs to delete the information item 404 in the contact list (or add the information item to the private space and the like), the user can execute a separation gesture on the information item 402 and the information item 406 adjacent to the information item 404 and display an animation of putting the information item 404 in a dustbin, so that the user operation is interesting, and the operation experience of the user is improved beneficially.

As shown in FIG. 4C, when the user needs to display the non-displayed information item 404 between the information item 402 and the information item 406 in the contact list on the display interface of the terminal 400, for example, the information item 404 is added to the private space, in related technology, the user needs to input a password in the private space and then set to display the information item 404, so that the operation process is tedious. By executing the separation gesture on the information item 402 and the information item 406, the information item 404 can be conveniently displayed, and the user does not need to set in the private space, thereby improving the operation efficiency of the user.

In addition, since the operation gesture can be set by the user, and meanwhile, when the user needs to display the linkman added to the private space, the user needs to confirms the position of the linkman in the contact list, so that the manner of not inputting the password and directly displaying the linkman in the private space in the contact list by the gesture is safe as well.

The technical solutions of the present invention have been illustrated above in detail in combination with the accompanying drawings, considering that in related technology, the user cannot conveniently operate the information items in the list, which is unbeneficial for the operation experience of the user. Therefore, the present invention proposes a new terminal operation solution, for enabling the user to conveniently manage the list on the terminal display interface by simple operations, thereby improving the operation efficiency and being conducive to improving the operation experience of the user.

According to the embodiments of the present invention, a program product stored on a nonvolatile machine-readable medium is further provided, for operating a terminal, and the program product includes an executable instruction used for driving a computer system to execute the following steps: displaying a list with a plurality of information items; judging whether displaying an information item between two specified information items according to a received operation instruction of the two specified information items in the list, so as to obtain a judgment result; and processing the information item between the two specified information items according to the judgment result.

According to the embodiments of the present invention, a nonvolatile machine-readable medium is further provided, a program product used for operating a terminal is stored in the nonvolatile machine-readable medium, the program product includes an executable instruction used for driving a computer system to execute the following steps: displaying a list with a plurality of information items; judging whether displaying an information item between two specified information items according to a received operation instruction of the two specified information items in the list, so as to obtain a judgment result; and processing the information item between the two specified information items according to the judgment result.

According to the embodiments of the present invention, a machine readable program is further provided, and the program drives a machine to execute any terminal operation method in the above technical solutions.

According to the embodiments of the present invention, a storage medium stored with a machine readable program is further provided, wherein the machine readable program drives a machine to execute any terminal operation method in the above technical solutions.

The foregoing descriptions are merely preferred embodiments of the present invention, rather than limiting the present invention. For those skilled in the art, the present invention can have a variety of modifications and variations. Any modifications, equivalent substitutions, improvements and the like made within the spirit and principle of the present invention shall fall into the protection scope of the present invention.

1. A terminal operation device, comprising:
a display unit used for displaying a list with a plurality of information items;
a judging unit used for judging whether displaying an information item between two specified information items according to a received operation instruction of the two specified information items in the list; and
a processing unit used for processing the information item between the two specified information items according to a judgment result of the judging unit.

2. The terminal operation device of claim 1, wherein the judging unit is specifically used for:
when receiving a first operation instruction of two spaced information items in the list, judging not to display the information item between the two spaced information items.

3. The terminal operation device of claim 2, wherein when the judging unit judges not to display the information item between the two spaced information items, the processing operation of the processing unit on the information item between the two spaced information items comprises:
deleting the information item between the two spaced information items, or storing the information item between the two spaced information items in a specified storage space or hiding the information item between the two spaced information items.

4. The terminal operation device of claim 3, further comprising:
an association unit used for associating the first operation instruction with a specified processing operation according to a received association instruction, for enabling the processing unit to process the information item between the two spaced information items according to the processing operation associated with the first operation instruction.

5. The terminal operation device of claim 3, wherein the processing unit is further used for:
when receiving the first operation instruction, selecting the processing operation on the information item between the two spaced information items according to the attribute of the information item between the two spaced information items, so as to process the information item between the two spaced information items.

6. The terminal operation device of claim 2,
wherein first operation instruction comprises a kneading gesture or a separation gesture.

7. The terminal operation device of claim 1, wherein the judging unit is further used for:
when receiving a second operation instruction of two adjacent information items in the list, judging to display a non-displayed information item between the two adjacent information items.

8. The terminal operation device of claim 7, wherein the second operation instruction comprises a separation gesture.

9. A terminal operation method, comprising:
displaying a list with a plurality of information items;
judging whether displaying an information item between two specified information items according to a received operation instruction of the two specified information items in the list, so as to obtain a judgment result; and
processing the information item between the two specified information items according to the judgment result.

10. The terminal operation method of claim 9, wherein when receiving a first operation instruction of two spaced information items in the list, judging not to display the information item between the two spaced information items.

11. The terminal operation method of claim 10, wherein the processing operation of not displaying the information item between the two spaced information items comprises:
deleting the information item between the two spaced information items, or storing the information item between the two spaced information items in a specified storage space or hiding the information item between the two spaced information items.

12. The terminal operation method of claim 11, wherein before receiving the first operation instruction of the two spaced information items in the list, the terminal operation method further comprises:
associating the first operation instruction with a specified processing operation according to a received association instruction, so as to process the information item between the two spaced information items according to the processing operation associated with the first operation instruction, when judging not to display the information item between the two spaced information items.

13. The terminal operation method of claim 10, wherein the first operation instruction comprises a kneading gesture or a separation gesture.

14. The terminal operation method of claim 9, wherein when receiving a second operation instruction of two adjacent information items in the list, judging to display a non-displayed information item between the two adjacent information items.

15. The terminal operation method of claim 14, wherein the second operation instruction comprises a separation gesture.

16. The terminal operation device of claim 3, wherein first operation instruction comprises a kneading gesture or a separation gesture.

17. The terminal operation device of claim 4, wherein first operation instruction comprises a kneading gesture or a separation gesture.

18. The terminal operation device of claim 5, wherein first operation instruction comprises a kneading gesture or a separation gesture.

19. The terminal operation method of claim 11, wherein the first operation instruction comprises a kneading gesture or a separation gesture.

20. The terminal operation method of claim 12, wherein the first operation instruction comprises a kneading gesture or a separation gesture.
